(19) United States
(12) Patent Application Publication
(10) Pub. No.: US 2024/0197112 A1
(43) Pub. Date: Jun. 20, 2024

(54) MULTI-FUNCTION ELECTRIC GRILL

(71) Applicant: SUNBEAM PRODUCTS, INC., Boca Raton, FL (US)

(72) Inventors: Elif Caputa, Boca Raton, FL (US); Zachary Lownds, Kalamazoo, MI (US); Rury Vizcarra, Grandville, MI (US)

(21) Appl. No.: 18/556,696

(22) PCT Filed: Apr. 25, 2022
(86) PCT No.: PCT/US22/71896

§ 371 Date: Oct. 23, 2023

Related U.S. Application Data
(60) Provisional application No. 63/178,926, filed on Apr. 23, 2021.
(60) Provisional application No. 63/315,573, filed on Mar. 2, 2022.

(51) Int. Cl. A47J 37/06; A47J 36/16; A47J 36/32; F24C 7/08; F24C 15/14; F24C 15/32

(52) U.S. Cl. CPC A47J 37/0611; A47J 36/16; A47J 36/32; A47J 37/0641; A47J 37/0664; F24C 7/087; F24C 15/14; F24C 15/325

(57) ABSTRACT

A multi-function electric grill is provided. The electric grill includes a removable lid, a body having a rear heating chamber and a main cooking chamber and a plurality of accessories configured to fit within the main cooking chamber. The electric grill also includes a rear heating element and a convection fan disposed within the rear heating chamber and a lower heating element within the main cooking chamber. A control interface of the electric grill is configured to selectively activate and deactivate the rear heating element, the convection fan, and the lower heating element based on a selected heating mode, a measured temperature within the main cooking chamber, and a programmed temperature for the main cooking chamber so as to cook a food item disposed on or within one of the plurality of accessories.

### CROSS-REFERENCE TO RELATED APPLICATIONS

This application claims priority to U.S. Application No. 63/178,926 filed Apr. 23, 2021 and titled “Electric Grill with Convection Module.” This Application also claims priority to U.S. Application No. 63/315,573 filed Mar. 2, 2022 and titled “MULTI-FUNCTION ELECTRIC GRILL.” U.S. Application No. 63/178,926 and U.S. Application No. 63/315,573 are hereby fully incorporated by reference as if set forth fully herein.

### FIELD OF INVENTION

The invention refers to electric grills. More specifically, the invention includes an electric grill with a convection module, nesting accessories, and a removable lid.

### BACKGROUND OF THE INVENTION

Portable electric grills and sandwich makers are well known in the art. Such grills generally include a housing which covers a heating element on which to grill or otherwise cook food. Typically, these units only cook food from underneath, thereby limiting the types of recipes that can be made. Cooking devices that allow cooking in a hollow unit with heaters in the lid are also known. However, these units have the disadvantage that food may become dried out and may be difficult to properly position and manipulate because the food is inside a hollow housing. Furthermore, positioning the heating element in the lid can make such cooking devices difficult to clean because the lid needs to maintain an electrical connection between the heating element and the electronics in the body.

In light of the foregoing, there is an ongoing need for an improved multi-function electric grill.

### SUMMARY OF THE INVENTION

Embodiments described herein include an electric grill comprising a body having a heating chamber and a main cooking chamber. The grill may include a first heating element and a convection fan disposed within the heating chamber, a second heating element within the main cooking chamber, and a control interface. The control interface can be configured to selectively activate and deactivate the first heating element, the convection fan, and the second heating element based on a selected heating mode for the main cooking chamber. In some embodiments, the electric grill can include a plurality of accessories configured to fit within the main cooking chamber. Furthermore, in some embodiments, the heating chamber can include a rear heating chamber positioned and located behind the main cooking chamber. In some embodiments, the control interface is further configured to selectively activate and deactivate the rear first heating element, the convection fan, and the lower second heating element further based on a measured temperature within the main cooking chamber and a programmed temperature.

In some embodiments, the electric grill can include a removable lid. The removable lid can include an inner surface having a geometry that facilitates flow of air from the first heating chamber into the main cooking chamber and facilitates air circulation within the main cooking chamber.

In yet other embodiments, the electric grill can include air flow channels that divide the main cooking chamber from the heating chamber to enable heated air to flow therebetween. The electric grill can include a conical interior wall in the heating chamber that surrounds the first heating element and the convection fan to direct air flow through the air flow channels.

### BRIEF DESCRIPTION OF THE DRAWINGS

For a better understanding of the various embodiments of the present invention, reference may be made to the accompanying drawings in which:

FIG. 1 is a front perspective view of an electric grill according to disclosed embodiments;

FIG. 2 is a front perspective view of an electric grill according to disclosed embodiments;

FIG. 3 is a front perspective view of a body of an electric grill according to disclosed embodiments;

FIG. 4 is a front perspective view of a body of an electric grill according to disclosed embodiments;

FIG. 5 is a side cross-section view of a body of an electric grill according to disclosed embodiments;

FIG. 6 is a front perspective view of a temperature distribution for an electric grill according to disclosed embodiments;

FIG. 7 is a top view of a temperature distribution for an electric grill according to disclosed embodiments;

FIG. 8 is a perspective view of nesting accessories for an electric grill according to disclosed embodiments;

FIG. 9 is an exploded view of nesting accessories for an electric grill according to disclosed embodiments;

FIG. 10 is a bottom view of one nested accessory for an electric grill according to disclosed embodiments;

FIG. 11 is a front perspective view of a top of an electric grill according to disclosed embodiments;

FIG. 12 is a bottom view of a top of an electric grill according to disclosed embodiments;

FIG. 13 is a cross-sectional view of a top of an electric grill according to disclosed embodiments; and

FIG. 14 is a cross-sectional view of a top of an electric grill according to disclosed embodiments.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE DRAWINGS

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

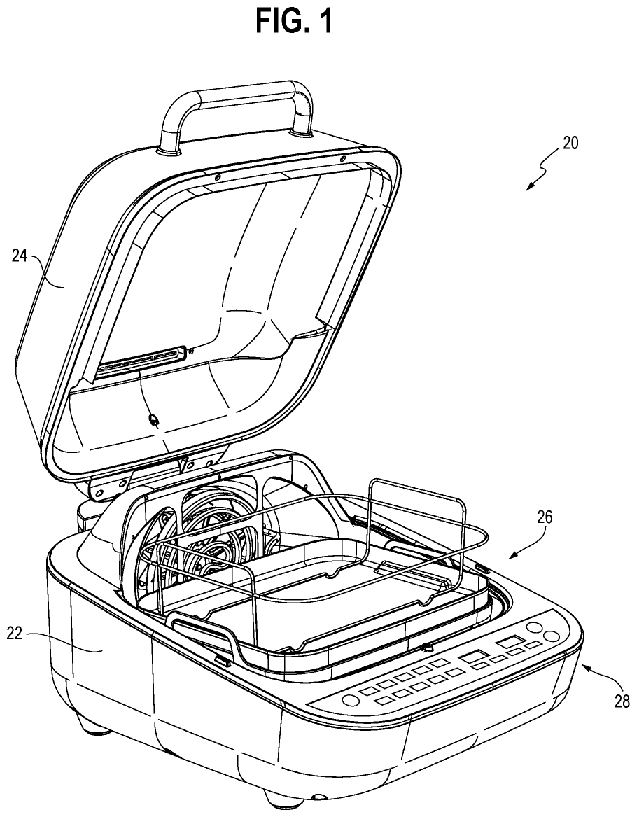

FIG. 1 shows a multi-function electric grill 20 according to disclosed embodiments. The electric grill 20 can include a body 22, a removable top or lid 24, and a plurality of nesting accessories 26 that can be used with the electric grill 20 to carry out a variety of cooking functions. The electric grill 20 can include a control interface 28 embedded in a front section of the body 22. The control interface 28 can include a plurality of buttons, switches, and an indicator screen such as known in the art for controlling various cooking operations of the electric grill 20. In some embodiments, the control interface 28 can include a wireless communication interface such as Wi-Fi, Bluetooth, or the like for wirelessly connecting the electric grill 20 to a remote control interface such as a smart phone or tablet. In these embodiments, the control interface 28 can be configured to send and/or receive control signals and status indicators to/from the remote control interface. In some embodiments, the control interface 28 can be configured to receive a heating mode selection such as a grill mode or a convection mode as described herein.

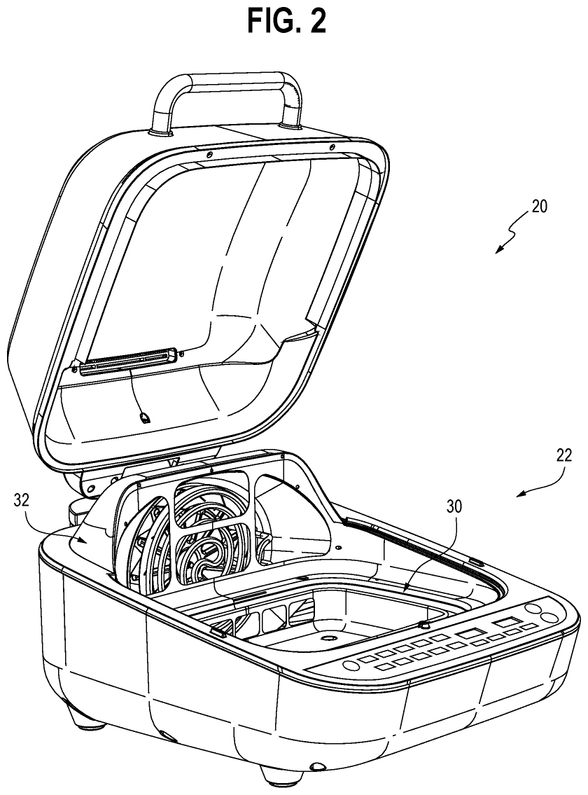

FIG. 2 shows the electric grill 20 with the plurality of nesting accessories 26 removed. As provided in FIG. 2, in some embodiments, the body 22 can include a main cooking chamber 30 configured to accommodate the plurality of nesting accessories 26, and a rear heating chamber 32 that can be used to carry out some cooking functions including convection and air frying, as set forth in greater detail below. In alternative embodiments, the heating chamber 32 could be positioned on a side or other surface of the electric grill 20.

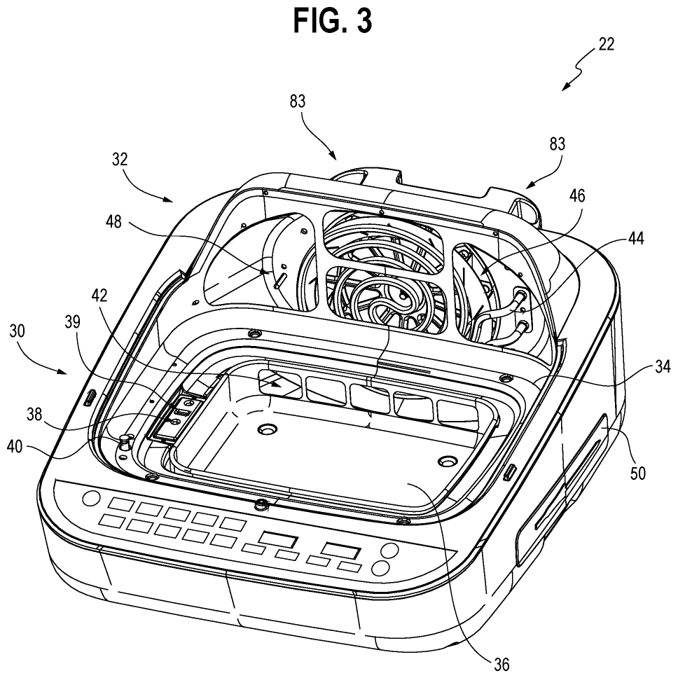

FIG. 3 illustrates the body 22 of the electric grill 20 according to disclosed embodiments. The body 22 can include a ledge 34 that is preferably configured to hold the plurality of nesting accessories 26 within an upper region of the main cooking chamber 30 above a lower region of the main cooking chamber 30 that can house a drip tray 36. In some embodiments, the ledge 34 can have a partially curved shape that securely holds one or more of the plurality of nesting accessories 26. The ledge 34 preferably defines the lower region to be slightly smaller than any of the nesting accessories 26 such that the nesting accessories 26 cannot fall into the drip tray 36 when in use.

Furthermore, in some embodiments, the body 22 can include an electric heater connection 38 for electrically coupling an electric heating element to a power source (not shown) and/or the control interface 28, a recessed latch 39, and a first temperature sensor 40. In some embodiments, the first temperature sensor 40 can be used to monitor temperature in the main cooking chamber 30 when the electric grill 20 is operated in the grill mode and/or the convection mode. Various locations for the first temperature sensor 40 are contemplated. Such locations can include but are not limited to, the ledge 34, a side of the body 22, the top 24, and other locations that would be known to those of skill in the art.

The drip tray 36 can include a plurality of air flow holes 42 configured to enable heated air to flow from the rear heating chamber 32 into the main cooking chamber 30 when the electric grill 20 is operated in the convection mode. Furthermore, in some embodiments, the body 22 can also include a rear heating element 44 positioned in the rear heating chamber 32 over a convection fan 46. In some embodiments, the rear heating element 44 can include one or more calrod heaters. The convection fan 46 can include a centrifugal (squirrel cage) fan or a traditional fan. Although various alternative configurations and positions for the rear heating element 44 and the convection fan 46 are contemplated, it is preferable that the convection fan 46 is not located within the top 24.

In some embodiments, the rear heating chamber 32 can include a second temperature sensor 48 that can be used to monitor temperature in the rear heating chamber 32 when the electric grill 20 is operated in the grill mode and/or the convection mode. Additionally or alternatively, in some embodiments, the body 22 can include an accessory drawer 50 for holding additional accessories for the electric grill 20 such as a food temperature probe (not shown). In these embodiments, the body 22 can also include an electrical port for coupling the food temperature probe to the control interface 28. In some embodiments, the control interface 28 can be configured to control operation of the grill mode and/or the convection mode based on temperature readings received from the food temperature probe.

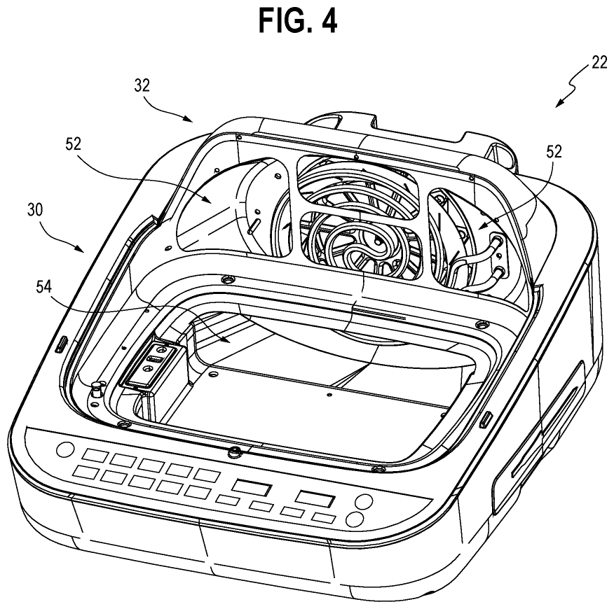

Turning to FIG. 4, the drip tray 36 can be configured to be removable from the main cooking chamber 30, for example by being lifted out of a recessed cavity that comprises the lower region of the main cooking chamber 30. Additionally or alternatively in some embodiments, the drip tray 36 can be configured to slide out from a side of the body 22. The body 22 may include upper air flow channels 52 and lower air flow channels 54 that divide the main cooking chamber 30 from the rear heating chamber 32 while enabling heated air to flow therebetween. In some embodiments, the lower air flow channels 54 can align at least partially with the air flow holes 42 of the drip tray 36 when the drip tray 36 is positioned in the main cooking chamber 30 so as to enable flow of heated air therethrough.

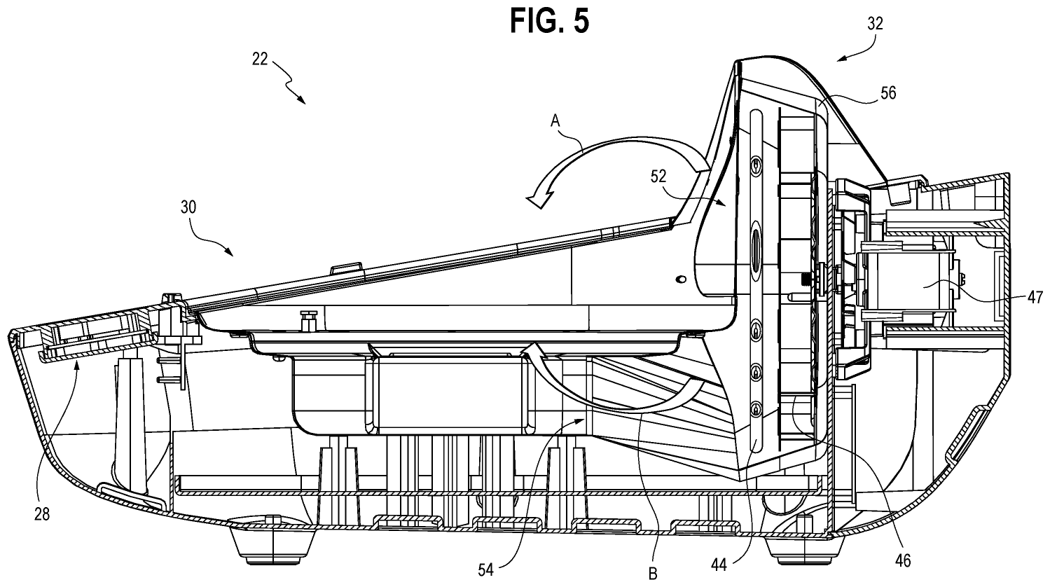

FIG. 5 is a side cross-section view of the body 22 according to disclosed embodiments. The rear heating chamber 32 can include a conical interior wall 56 that surrounds the rear heating element 44 and the convection fan 46 to direct air flow through the upper air flow channels 52 as shown by the arrow A and through the lower air flow channels 54 as shown by the arrow B when the electric grill 20 is operated in the convection mode. In some embodiments, the body 22 can include a fan motor 47 positioned in the rear heating chamber 32 behind the convection fan 46 for rotating the convection fan 46 in response to signals from the control interface 28. In some embodiments, the control interface 28 can include a printed circuit board having one or more integrated chips and processors for executing one or more cooking modes of the electric grill 20 such as the grill and convection cooking modes described herein.

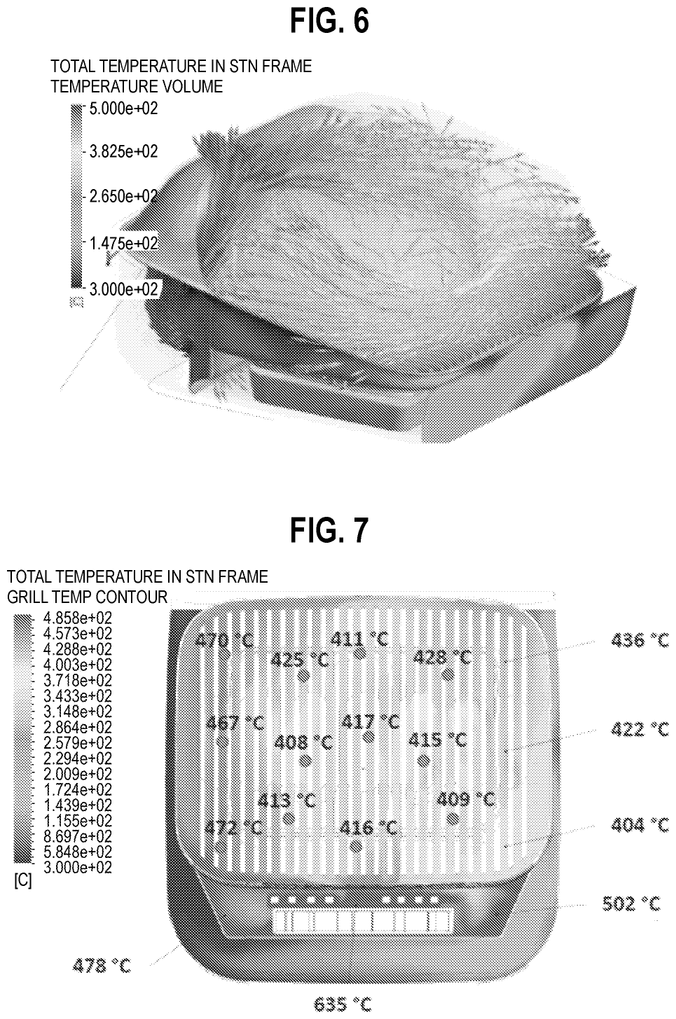

FIG. 6 and FIG. 7 are temperature distribution graphs for the electric grill 20 after approximately eight seconds of operating in the convection mode according to disclosed embodiments. As provided, in some embodiments, the geometries of the upper air flow channels 52, the lower air flow channels 54, the conical interior wall 56, and/or the top 24 can interact to spread heated air efficiently and evenly throughout the main cooking chamber 30 when the electric grill 20 is operated in the convection mode. In particular, these geometries can include the cone shape of the conical interior wall 56, the locations of the of the upper air flow channels 52 and the lower air flow channels 54, and the curved interior shape of the top 24. For example, in some embodiments, the cone shape of the conical interior wall 56 can direct or funnel heated air radiating from the convection fan 46 and the rear heating element 44 out from the rear heating chamber 32 through the upper air flow channels 52 and the lower air flow channels 54. Then, some portions of the heated air that flow though the upper air flow channels 52 can be mixed in the main cooking chamber 30 by a curved shape of the inside of the top 24, as described in more detail below.

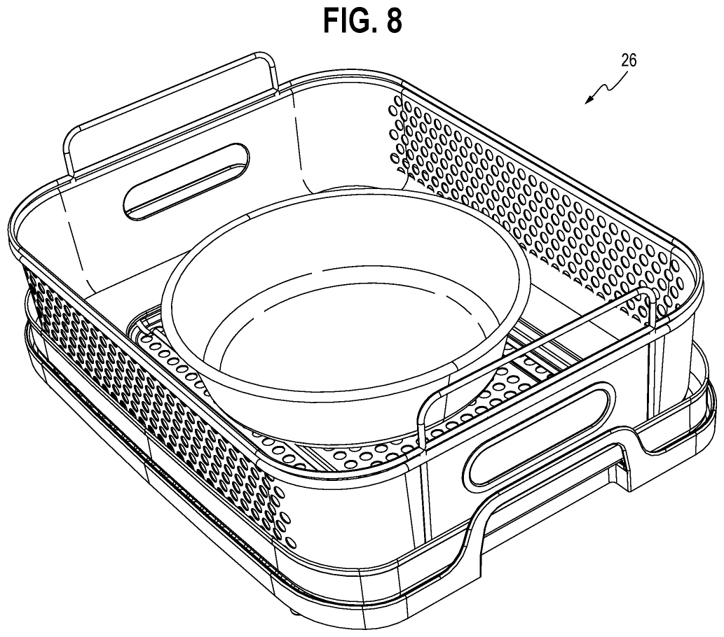

FIG. 8 is a perspective view of the plurality of nesting accessories 26 according to disclosed embodiments. In some embodiments, each of the plurality of nesting accessories 26 can be configured to nest together such that they can be stored inside the electric grill 20 when not in use (see FIG. 1).

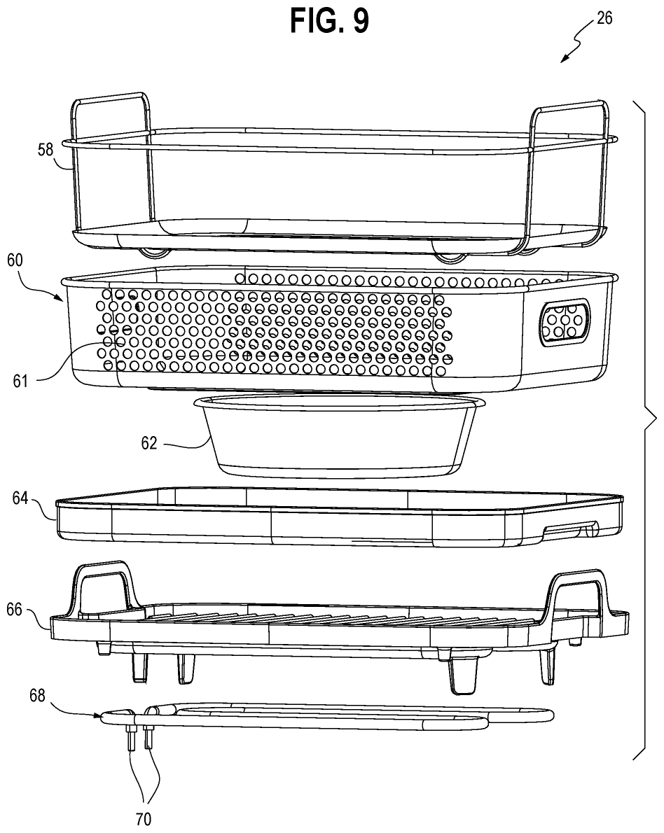

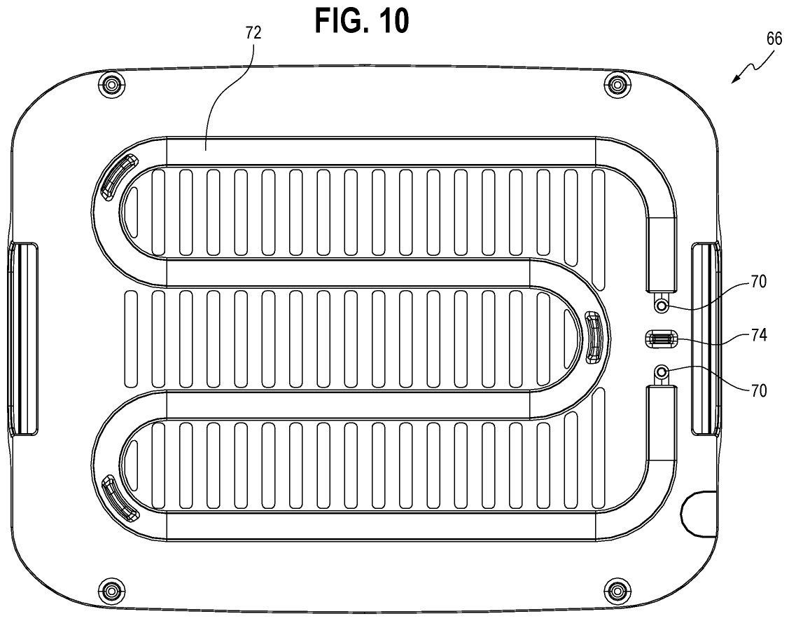

FIG. 9 is an exploded view of the plurality of nesting accessories 26 according to disclosed embodiments. In some embodiments, the plurality of nesting accessories 26 can include a rack 58, an air fry basket 60, a baking pan 62, a griddle 64, a cooking plate 66, and a lower heating element 68. Additional accessories such as a smoke tube for heating wood pellets or chips and adding smoke to food are contemplated. In some embodiments, the rack 58 can be configured to enable use of additional standard backing or cooking pans within the electric grill 20. Additionally or alternatively, in some embodiments, the air fry basket 60 can be configured to nest inside the rack 58 such that the rack 58 enable air flow through an underside of the air fry basket 60. Furthermore, in some embodiments the air fry basket 60 can include a plurality of apertures 61 cut out from the bottom and sides so as to enable heated air to flow around a food item placed therein. In some embodiments, the air fry basket 60 can include metal mesh construction known in the art to facilitate such air flow. As seen in FIG. 9, in some embodiments, the lower heating element 68 can include electrical contacts 70 configured to interface with the electric heater connection 38 (see FIG. 3) in the body 22. In some embodiments, when the lower heating element 68 is connected to the electric heater connection 38 via the electrical contacts 70, the electric grill 20 can be operated in the grill mode by the control interface 28.

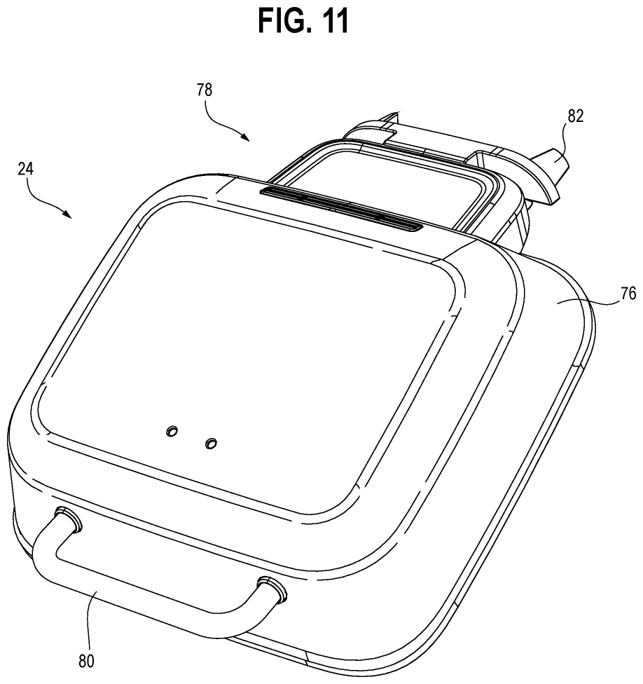

FIG. 10 is a bottom view of the cooking plate 66 according to disclosed embodiments. In some embodiments the cooking plate 66 can include a housing 72 that surrounds and contains the lower heating element 68 and provides an opening for the electrical contacts 70. However, alternative embodiments where the lower heating element 68 is not embedded in the cooking plate 66 are also contemplated. Furthermore, in some embodiments, the cooking plate 66 can include protrusions 74 configured to interface with the recessed latch 39 (see FIG. 3) so as to secure the cooking plate 66 and the lower heating element 68 within the main cooking chamber 30. In some embodiments, the recessed latch 39 can include a sensor that informs the control interface 28 that the cooking plate 66 and lower heating element 68 have been installed in the main cooking chamber 30. In some embodiments, the lower heating element 68 can include one or more calrod heaters.

In some embodiments, the cooking plate 66 can include a support surface configured to support food placed thereon, and the lower heating element 68 can be configured to heat the cooking plate 66 from below. As such, the food is preferably not located between the lower heating element 68 and the cooking plate 66. In some embodiments, the convection mode is configured so that food on the support surface of the cooking plate 66 is not heated sufficiently to cause a Maillard reaction. In some embodiments, the cooking plate 66 can include a grill plate with grooves of any shape, or a skillet (or similar flat design). The cooking plate 66 can also be configured to be even with or raised with respect to sides of the electric grill 20. As such, when the top 24 is raised, food is not encased by the sides of the electric grill 20. In some embodiments, the cooking plate 66 can include a sheet metal plate. Alternatively, the cooking plate 66 can be a cast metal plate.

FIGS. 11-14 illustrate the top 24 of the electric grill 20 removed from the body 22 according to disclosed embodiments. In some embodiments, the top 24 can include an outer surface 76, a hinge section 78, a handle 80, and couplers 82 configured to removably couple the top 24 to and from receiving slots 83 (see FIG. 3) in the body 22. In some embodiments, the couplers 82 and the receiving slots 83 can include electrical contacts for providing an electrical connection to any electrical elements positioned in the top 24. For example, in some embodiments, the top 24 can include a third temperature sensor, a third heating element, a second fan, etc. that are electrically coupled to the control interface 28 via electrical contacts on the couplers 82. Because the top 24 is preferably removable from the body 22, cleaning of the grill 20 is made much easier. In some embodiments, the top 24 may be permanently or semi-permanently coupled to the body 22.

In some embodiments, the hinge section 78 can be configured to move between a first fully opened position and a closed position. When the top 24 is coupled to the body 22 and in the closed position, the top 24 can enclose both the heating chamber 32 and the main cooking chamber 30. Furthermore, the hinge section 78 can be configured with a plurality of stops that hold the top 24 at a variety of different angles. For example, in some embodiments the hinge section 78 can include a stop at 72 degrees for fully opened, an intermediate stop at 36 degrees corresponding to a second open position, and a stop at a fully closed position where the top 24 encloses the main cooking chamber 30. Additional and alternative angles are also contemplated.

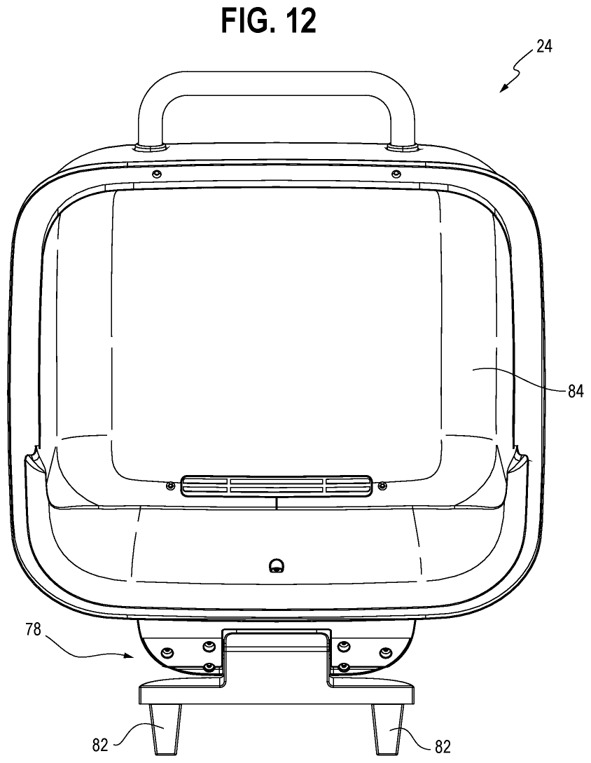

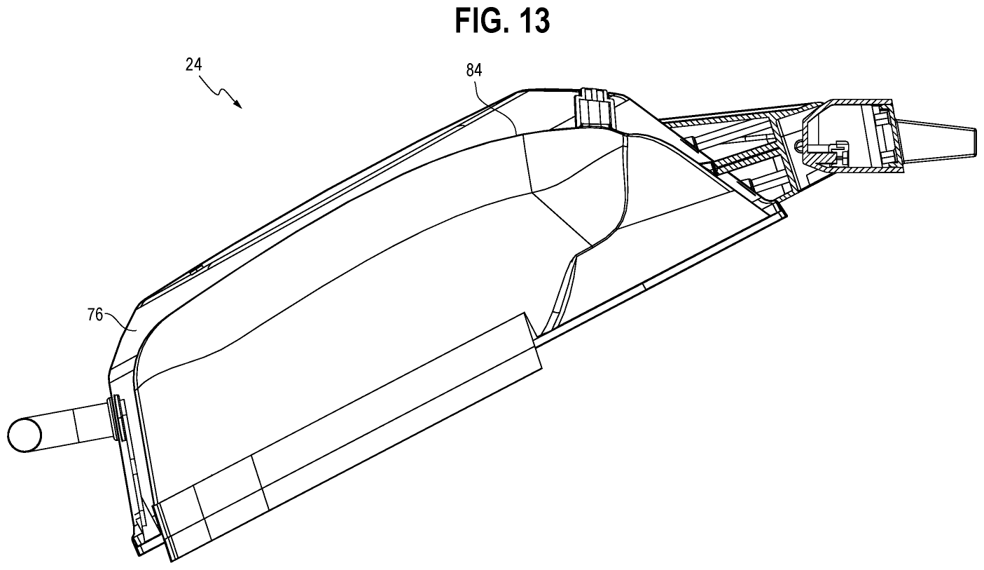

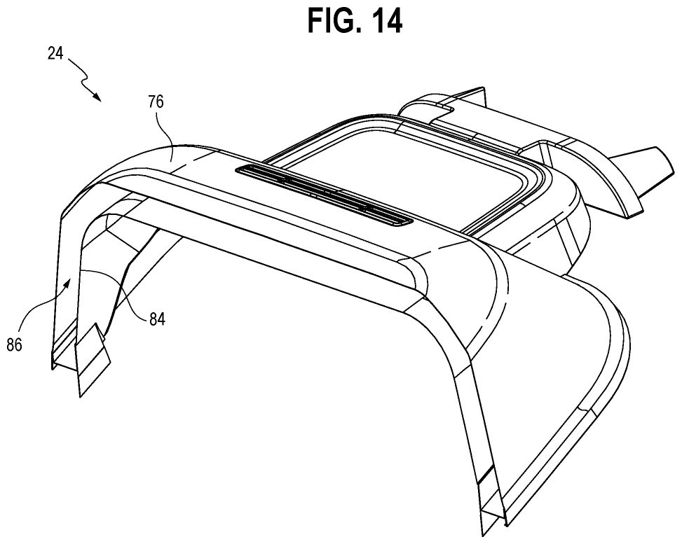

FIG. 12 is a bottom view of the top 24 according to disclosed embodiments. As seen in FIG. 12, in some embodiments, the top 24 can include an inner surface 84. In some embodiments such as the cross-sections shown in FIG. 13 and FIG. 14, the inner surface 84 can be offset from the outer surface 76 to impart a gap 86 therebetween. In some embodiments, the gap 86 can be a vacuum or other insulating region to assist in preventing heat from radiating out of the main cooking chamber 30. Furthermore, as illustrated in FIG. 13, in some embodiments, the inner surface 84 can have a different geometry from the outer surface 76. For example, in some embodiments, the inner surface 84 can include a relatively smooth curved surface that facilitates the flow of air from the rear heating chamber 32 into the main cooking chamber 30 (to the top and/or bottom of the cooking area) and facilitates air circulation within the main cooking chamber 30.

As described herein, various operating modes for the electric grill 20 are contemplated. In particular, the electric grill 20 can be configured to operate in one or both of the grill mode and the convection mode. In some embodiments, the control interface 28 can initiate the convection mode by activating the rear heating element 44 and the convection fan 46 to heat and circulate air through the rear heating chamber 32 and the main cooking chamber 30 as described herein. In some embodiments, the control interface 28 can then monitor a temperature of the rear heating chamber 32 and the main cooking chamber 30 using the first and second temperature sensors 40 and 48 and selectively activate and deactivate the rear heating element 44 and the convection fan 46 to maintain a programmed temperature within the main cooking chamber 30. For example, the control interface can be configured to control activation of the lower heating element 68, the rear heating element 44, and the convection fan 46 based on results of a comparison of the programmed temperature to respective temperature values of the first and second temperature sensors 40 and 48. As such, in some embodiments, the control interface 28 can also activate the lower heating element 68 in the convection mode.

Similarly, the control interface 28 can initiate the grill mode by activating the lower heating element 68 to begin heating the cooking plate 66 and/or radiating heat upward. In some embodiments, the control interface 28 can then monitor a temperature of the cooking plate 66 and/or the main cooking chamber 30 using the first temperature sensor 40 and selectively activate and deactivate the lower heating element 68 to maintain a programmed temperature of the cooking plate 66 and or within the main cooking chamber 30. In some embodiments, when in the grill mode, the control interface 28 can also monitor the temperature of the grill 20 using the second temperature sensor 48 even though the rear heating element 44 and the convection fan 46 are not activated. For example, the control interface 28 can be configured to control the activation of the lower heating element 68 based on results of a comparison of the programmed temperature to the respective temperature values of the first and second temperature sensors 40 and 48. Further still in some embodiments, the control interface 28 can activate the convection fan 46 in the grill mode while the rear heating element 44 remains inactive. Various other operational modes understood by those of ordinary skill in the art are also contemplated.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An electric grill comprising:
a body having a heating chamber and a main cooking chamber, the main cooking chamber being separate from the heating chamber;
a lid hingedly coupled to the body and configured to move between a first open position and a closed position, wherein the lid encloses both the heating chamber and the main cooking chamber when in the closed position;
a first heating element and a convection fan disposed within the heating chamber;
a second heating element disposed within the main cooking chamber; and
a control interface configured to receive a heating mode selection;
wherein, when the heating mode selection includes a convection mode, the control interface is configured to activate the first heating element, the second heating element, and the convection fan; and
wherein when the heating mode selection includes a grill mode, the control interface is configured to activate the second heating element while failing to activate the first heating element and the convection fan.

2. The electric grill of claim 1 further comprising a plurality of accessories configured to nest together to fit within the main cooking chamber.

3. The electric grill of claim 2 further comprising a ledge configured to hold the plurality of accessories within the main cooking chamber above a lower region of the main cooking chamber.

4. The electric grill of claim 3 further comprising a drip tray configured to removably nest inside the lower region of the main cooking chamber underneath the plurality of accessories.

5. The electric grill of claim 4 further comprising lower air flow channels that divide the lower region of the main cooking chamber from the heating chamber,
wherein the lower air flow channels are configured to enable air heated by the first heating element to flow from the heating chamber into the lower region of the main cooking chamber, and
wherein the drip tray includes air flow holes configured to align with the lower air flow channels when the drip tray is nested within the lower region of the main cooking chamber.

6. The electric grill of claim 2 wherein the second heating element is embedded in one of the plurality of accessories.

7. The electric grill of claim 6 wherein the one of the plurality of accessories in which the second heating element is embedded includes a protrusion configured to interface with a recessed latch located in the main cooking chamber so as to secure one of the plurality of accessories and the second heating element within the main cooking chamber;
wherein the second heating element includes electrical contacts configured to interface with an electric heater connection in the body; and
wherein the control interface is configured to refrain from activating the second heating element in both the grill mode and the convection mode when the control interface fails to detect that the electrical contacts are interfaced with the electric heater connection and that the protrusion is interfaced with the recessed latch.

8. The electric grill of claim 1 wherein the heating chamber is a rear heating chamber positioned and located behind the main cooking chamber.

9. The electric grill of claim 1 further comprising a first temperature sensor disposed in the main cooking chamber and a second temperature sensor disposed in the heating chamber.

10. The electric grill of claim 9, wherein the control interface is further configured to receive a programmed temperature and compare the programmed temperature to respective temperature values of the first and second temperature sensors,
wherein when the heating mode selection includes the convection mode, the control interface is configured to further control the activation of the first heating element, the second heating element, and the convection fan based on results of the comparison of the programmed temperature to the respective temperature values of the first and second temperature sensors, and
wherein when the heating mode selection includes the grill mode, the control interface is further configured to control the activation of the second heating element based on the results of the comparison of the programmed temperature to the respective temperature values of the first and second temperature sensors.

11. The electric grill of claim 1 wherein the lid is removably coupled to the body.

12. The electric grill of claim 11 wherein the lid includes couplers that removably fit within receiving slots of the body to removably couple the lid to the body.

13. The electric grill of claim 1 wherein the lid includes an inner surface having a curved geometry that facilitates flow of air from the heating chamber into the main cooking chamber and facilitates air circulation within the main cooking chamber.

14. The electric grill of claim 13 wherein the lid includes an outer surface separated from the inner surface by a gap, wherein the outer surface has a shape different from the curved geometry of the inner surface.

15. The electric grill of claim 1 further comprising air flow channels that divide the main cooking chamber from the heating chamber to enable heated air to flow therebetween.

16. The electric grill of claim 15 wherein the air flow channels include upper air flow channels that that divide an upper region of the main cooking chamber from the heating chamber, wherein the air flow channels include lower air flow channels that divide a lower region of the main cooking chamber from the heating chamber, wherein the upper air flow channels are configured to enable air heated by the first heating element to flow from the heating chamber into the upper region of the main cooking chamber, and wherein the lower air flow channels are configured to enable the air heated by the first heating element to flow from the heating chamber into the lower region of the main cooking chamber.

17. The electric grill of claim 15 further comprising a conical interior wall in the heating chamber that surrounds the first heating element and the convection fan to direct air flow through the air flow channels.

18. The electric grill of claim 1 wherein a hinge section of the lid includes a plurality of stops that hold the lid at the first open position and a second open position, wherein an angle formed between the lid and the body is greater in the first open position than in the second open position, and wherein the angle formed between the lid and the body is greater in the second open position than in the closed position.

19. An electric grill comprising:
a body having a heating chamber and a main cooking chamber, the main cooking chamber being separated from the heating chamber by air flow channels that enable flow of air from the heating chamber into the main cooking chamber;
a lid having a hinge section with couplers that fit within receiving regions of the body to removably couple the lid to to the body, wherein, when the lid is coupled to the body the hinge section is configured to move the lid between a first open position and a closed position, and wherein the lid encloses both the heating chamber and the main cooking chamber when in the closed position;
a first heating element and a convection fan disposed within the heating chamber;
a removable cooking plate including a second heating element embedded therein, wherein the cooking plate is removably coupled to the body within the main cooking chamber; and
a control interface configured to receive a heating mode selection;
wherein, when the heating mode selection includes a convection mode, the control interface is configured to activate the first heating element, the second heating element, and the convection fan;
wherein when the heating mode selection includes a grill mode, the control interface is configured to activate the second heating element while failing to activate the first heating element, and the convection fan; and
wherein the control interface is configured to refrain from activating the second heating element in either the grill mode or the convection mode when the control interface fails to detect that the removable cooking plate is coupled to the body.

20. The electric grill of claim 19 wherein the air flow channels include upper air flow channels that that divide an upper region of the main cooking chamber from the heating chamber, wherein the air flow channels include lower air flow channels that that divide a lower region of the main cooking chamber from the heating chamber, wherein the heating chamber is a rear heating chamber positioned and located behind the main cooking chamber, and wherein the rear heating chamber includes a conical interior wall that surrounds the first heating element and the convection fan to direct air flow through the upper air flow channels and the lower air flow channels.
